(19) United States
(12) Patent Application Publication
(10) Pub. No.: US 2026/0051040 A1
(43) Pub. Date: Feb. 19, 2026

(54) METHOD FOR AUTOMATICALLY MEASURING SEMICONDUCTOR STRUCTURE BASED ON TRAINING OF SEMICONDUCTOR IMAGE SEGMENTATION FOUNDATION MODEL

(71) Applicant: Samsung Electronics Co., Ltd., Suwon-si (KR)

(72) Inventors: Sangho Yoon, Suwon-si (KR); SU-BONG SHON, Suwon-si (KR); Yunsoo Kim, Suwon-si (KR); Joonyoung Ahn, Suwon-si (KR); Wonho Chae, Suwon-si (KR); Hyunsu Choi, Suwon-si (KR)

(21) Appl. No.: 19/061,705

(22) Filed: Feb. 24, 2025

(30) Foreign Application Priority Data
Aug. 16, 2024 (KR) 10-2024-0109944

(51) Int. Cl. G06T 7/00

(52) U.S. Cl. CPC G06T 7/0006; G06T 2207/10056; G06T 2207/20081; G06T 2207/30148

(57) ABSTRACT

Disclosed is a method for automatically measuring a semiconductor structure, which may include: creating source ground truth data for a source raw image including a microscope image of the semiconductor structure, in which the source ground truth data includes a source ground truth image, and information thereon; learning a foundation model based on the source raw image, and on the information on the source ground truth image; creating respective ground truth data for a respective raw image by utilizing the learned foundation model, wherein the respective ground truth data includes an respective ground truth image and respective information therefor; and learning the foundation model based on the respective raw image, and on the respective information thereon, in which the creating of the respective ground truth data, and the learning of the foundation model based on the respective raw image, and on the respective information may be repeated.

### CROSS-REFERENCE TO RELATED APPLICATION

This application claims priority to and the benefit of Korean Patent Application No. 10-2024-0109944 filed in the Korean Intellectual Property Office on Aug. 16, 2024, the entire contents of which are incorporated herein by reference.

### BACKGROUND OF THE INVENTION

### (a) Field of the Invention

The present disclosure relates to a method for automatically measuring a semiconductor structure based on learning of a semiconductor image segmentation foundation model.

### (b) Description of the Related Art

An electron microscope (for example, a scanning electron microscope or a transmission electron microscope) is one of the representative devices for analyzing a semiconductor structure, and is used to analyze the geometry and/or core structure of semiconductor devices in detail. While a structure of a semiconductor device (e.g., an integrated circuit formed as a semiconductor chip, a memory device such as DRAM or Flash, and/or a logic circuit) is miniaturized with the development of a semiconductor technology, a technology is used, which captures an image for the structure of the semiconductor device with the electron microscope, measures the structure and a specification of the semiconductor device from the image, and analyzes a measurement result.

An existing analysis technology using the electron microscope is generally performed by manual analysis, e.g. by a user. However, since the manual analysis by the user takes a long time, the amount of analysis per unit time is necessarily limited. Further, due to an uncertain boundary surface having the miniaturized structure of the semiconductor device, it is difficult for the user to unambiguously define a criterion for a boundary between materials or structures, and even if the same image is analyzed, the result of the analysis may vary depending on the user. Referring to part (a) of FIG. 1, it can be seen that it is not easy to distinguish a boundary for the structures of the semiconductor device miniaturized within an image captured by the electron microscope, and analysis values for the structures of the semiconductor device vary depending on a user A1, A2, or A3.

In order to solve problems due to the manual analysis, a technology is developed and used, which creates image segmentation ground truth data for the image captured by the electron microscope (see part (b) of FIG. 1), and analyzes the structures of the semiconductor device based on the image segmentation ground truth data (see part (c) of FIG. 1). For example, ground truth data may refer to observed or factual data.

However, in some cases, products may be a target of the image segmentation ground truth data, and may have a very large number of structures in the product. Moreover, a criterion for the structure may require consultation between users, and when an error occurs in the analysis value, the image segmentation ground truth data may need to be created through the processes again. As a result, significant effort and time may be consumed to create the image segmentation ground truth data.

### SUMMARY OF THE INVENTION

The present disclosure attempts to provide a semiconductor image segmentation foundation model for creating images segmentation ground truth data.

The present disclosure attempts to provide a system and a method for automatically measuring a semiconductor structure (e.g., the geometry and/or core structure of an integrated circuit, semiconductor chip, a memory device such as DRAM or Flash, a logic circuit, another semiconductor device, or lot) based on learning of a semiconductor image segmentation foundation model.

An embodiment of the present disclosure provides a method for automatically measuring a semiconductor structure, which may include: receiving a microscope image of the semiconductor structure, creating source ground truth data for a source raw image including the microscope image of the semiconductor structure, in which the source ground truth data includes a source ground truth image, and information on the source ground truth image; learning a foundation model based on the source raw image, and based on the information on the source ground truth image; creating respective ground truth data for an respective raw image by utilizing the learned foundation model, wherein the respective ground truth data includes an respective ground truth image and respective information for the respective ground truth image; and learning the foundation model based on the respective raw image, and based on the respective information on the respective ground truth image, in which the creating of the respective ground truth data for the respective raw image by utilizing the learned foundation model, and the learning of the foundation model based on the respective raw image, and based on the respective information for the respective ground truth image may be repeated.

Another embodiment of the present disclosure provides a method for automatically measuring a semiconductor structure, which may include: receiving a microscope image of the semiconductor structure, creating source ground truth data for a source raw image including the microscope image of the semiconductor structure, in which the source ground truth data includes a source ground truth image, and source metadata stored in the source ground truth image; creating a file including the source raw image and the source ground truth data, and storing the file in a database to manage the source ground truth data; separating the source raw image and the source ground truth data from the file, and extracting the source metadata from the source ground truth data; learning a foundation model based on the source raw image, and based on the extracted source metadata; creating ground truth data for a raw image by utilizing the learned foundation model, wherein the ground truth data includes a ground truth image, and metadata stored in the ground truth image; creating an additional file including the raw image and the ground truth data, and storing the additional file in the database to manage the ground truth data; separating the raw image and the ground truth data from the additional file, and extracting the metadata from the ground truth data; and learning the foundation model based on the raw image, and based on the extracted metadata, in which the creating of the ground truth data, the managing of the ground truth data, the separating of the raw image and the ground truth data from the additional file, and extracting of the metadata from the ground truth data, and the learning of the foundation model based on the raw image and based on the extracted metadata may be repeated.

Yet another embodiment of the present disclosure provides a method for automatically measuring a semiconductor structure, which may include: receiving a plurality of microscope images of one or more semiconductor structure, creating a plurality of source ground truth data for a plurality of source raw images, wherein each of the plurality of source raw images includes a respective one of the plurality of microscope images of the one or more semiconductor structure; creating a plurality of files each including respective source ground truth data among the plurality of source ground truth data, and a corresponding raw image among the plurality of source raw images, and storing the plurality of files in a database to manage the plurality of source ground truth data; learning a foundation model by utilizing the plurality of files stored in the database; creating ground truth data for a raw image by utilizing the learned foundation model; creating an additional file including the ground truth data and the raw image, and storing the additional file in the database to manage the ground truth data; learning the foundation model by utilizing the additional file stored in the database, wherein the creating of the ground truth data, the managing of the ground truth data, and the learning of the foundation model by utilizing the additional file are repeated; learning an image segmentation model by utilizing the plurality of files stored in the database, and utilizing a plurality of additional files stored in the database, and including respective additional files created by the repeated creating of the ground truth data, managing of the ground truth data, and learning of the foundation model by utilizing the additional file; inferring a new image by utilizing the image segmentation model to create an inferred image; and measuring one or more feature of the one or more semiconductor structure from the inferred image.

Image segmentation ground truth data having high analysis accuracy can be rapidly created.

The image segmentation ground truth data is managed, and recycled to rapidly create image segmentation ground truth data for a new semiconductor device, and enhance the accuracy of the image segmentation ground truth data for the new semiconductor device.

### BRIEF DESCRIPTION OF THE DRAWINGS

FIG. 1 is a diagram illustrating an image in related art, an image segmentation ground truth image for the image in the related art, and an image segmentation ground truth image.

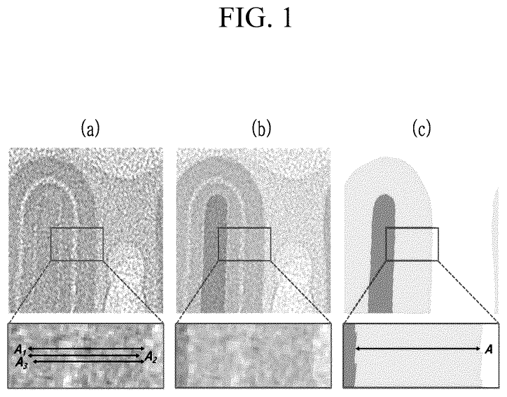

FIG. 2 is a diagram illustrating a system and a method for automatically measuring a semiconductor structure according to an embodiment.

FIG. 3 is a diagram illustrating a system and a method for automatically measuring a semiconductor structure according to an embodiment.

FIG. 4 is a diagram illustrating a step of creating source ground truth data from a source raw image.

FIG. 5 is a diagram illustrating a step of learning a foundation model of FIG. 3.

FIG. 6 is a diagram illustrating a step of creating ground truth data of FIG. 3.

FIG. 7 is a diagram illustrating a step of creating ground truth data of FIG. 3.

FIG. 8 is a diagram illustrating comparison of performances of a ground truth image in other systems and a ground truth image of the present disclosure.

FIG. 9 is a graph evaluating and illustrating the performance of the ground truth data learned by the foundation model.

### DETAILED DESCRIPTION OF THE EMBODIMENTS

Hereinafter, an embodiment of the present disclosure will be described more fully hereinafter with reference to the accompanying drawings so as to be easily implemented by those skilled in the art to which the present disclosure pertains. The present disclosure may be implemented in various different forms and is not limited to embodiments described herein.

Parts not associated with required description are omitted for clearly describing the present invention and like reference numerals designate like elements throughout the specification.

In addition, unless explicitly described to the contrary, the word “comprise”, and variations such as “comprises” or “comprising”, will be understood to imply the inclusion of stated elements but not the exclusion of any other elements. Throughout the specification, when a component is described as “including” a particular element or group of elements, it is to be understood that the component is formed of only the element or the group of elements, or the element or group of elements may be combined with additional elements to form the component, unless the context indicates otherwise. The term “consisting of,” on the other hand, indicates that a component is formed only of the element(s) listed.

As used herein, a semiconductor device may refer, for example, to a device such as a semiconductor chip (e.g., memory chip and/or logic chip formed on a die), a stack of semiconductor chips, a semiconductor package including one or more semiconductor chips stacked on a package substrate, or a package-on-package device including a plurality of packages. These devices may be formed using ball grid arrays, wire bonding, through substrate vias, or other electrical connection elements, and may include memory devices such as volatile or non-volatile memory devices. Semiconductor packages may include a package substrate, one or more semiconductor chips, and an encapsulant formed on the package substrate and covering the semiconductor chips.

The present disclosure now will be described more fully hereinafter with reference to the accompanying drawings, in which various embodiments are shown. The invention may, however, be embodied in many different forms and should not be construed as limited to the example embodiments set forth herein. These example embodiments are just that—examples—and many implementations and variations are possible that do not require the details provided herein. It should also be emphasized that the disclosure provides details of alternative examples, but such listing of alternatives is not exhaustive. Furthermore, any consistency of detail between various examples should not be interpreted as requiring such detail—it is impracticable to list every possible variation for every feature described herein. The language of the claims should be referenced in determining the requirements of the invention.

Hereinafter, a system 10 and a method for automatically measuring a semiconductor structure according to an embodiment of the present disclosure will be described with reference to drawings.

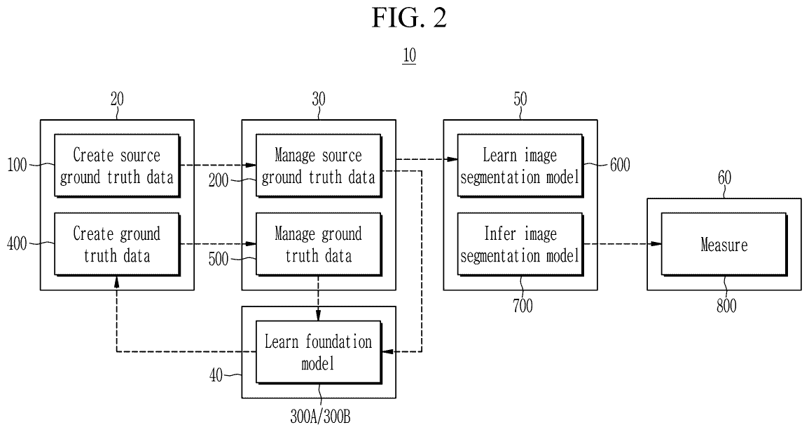

FIG. 2 is a diagram illustrating a system 10 and a method for automatically measuring a semiconductor structure (e.g., the geometry and/or core structure of an integrated circuit, semiconductor chip, a memory device such as DRAM or Flash, a logic circuit, another semiconductor device, or lot) according to an embodiment.

Referring to FIG. 2, the system 10 for automatically measuring a semiconductor structure may include a ground truth data creation unit 20, a ground truth data management unit 30, a foundation model 40, an image segmentation model 50, and a measurement unit 60. In some examples, the system 10 for automatically measuring a semiconductor structure may be implemented via hardware and/or software, such as a computer (or several interconnected computers). The system 10 may include, for example, one or more processors configured by software, such as a CPU (Central Processing Unit), GPU (graphics processor), controller, etc., and include ground truth data creation unit 20, a ground truth data management unit 30, a foundation model 40, an image segmentation model 50, and a measurement unit 60, and the like, forming various functional modules of the system 10. The computer may be a general purpose computer or may be dedicated hardware or firmware (e.g., an electronic or optical circuit, such as application-specific hardware, such as, for example, a digital signal processor (DSP) or a field-programmable gate array (FPGA)). A computer may be configured from several interconnected computers. Each functional module (or unit) described herein may comprise a separate computer, or some or all of the functional module (or unit) may be comprised of and share the hardware of the same computer. Connections and interactions between the units described herein may be hardwired and/or in the form of data (e.g., as data stored in and retrieved from memory of the computer, such as a register, buffer, cache, storage drive, etc., such as part of an application programming interface (API)). The functional modules (or units) of the system 10 (e.g., ground truth data creation unit 20, a ground truth data management unit 30, a foundation model 40, an image segmentation model 50, and a measurement unit 60) may each correspond to a separate segment or segments of software (e.g., a subroutine) which configure the computer of the system 10, and/or may correspond to segment(s) of software that also correspond to one or more other functional modules (or units) described herein (e.g., the functional modules (or units) may share certain segment(s) of software or be embodied by the same segment(s) of software). As is understood, “software” refers to prescribed rules to operate a computer, such as code or script. Storage 12 may comprise conventional memory of a computer, such as a hard drive (which may be a solid state drive, DRAM, NAND flash memory, etc.). Operation unit 13 may comprise a conventional computer user interface and include input devices, such as a keyboard, mouse, trackpad, touchscreen, etc.

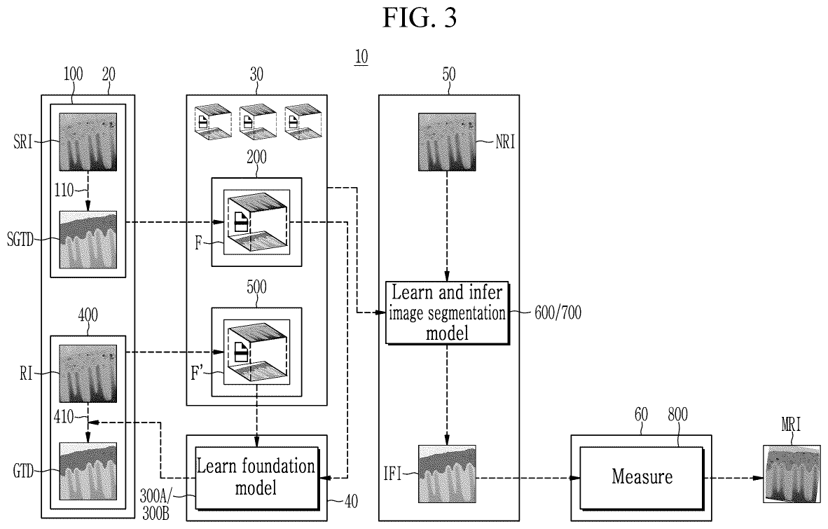

Following the method for automatically measuring a semiconductor structure, the ground truth data creation unit 20 may perform a step S100 of creating source ground truth data (SGTD) (see FIG. 3), and a step S400 of creating ground truth data (GTD) (see FIG. 3). The ground truth data creation unit 20 may include a passive annotation unit, a super pixel annotation unit, a first image segmentation unit, a second image segmentation unit, and a third image segmentation unit (not illustrated). The passive annotation unit may perform labeling for an image segmentation region by using a drawing tool based on an input of a user. The super pixel annotation unit may create a super pixel for a target image, form the image segmentation region based on the super pixel, and perform the labeling for the image segmentation region. A first image segmentation unit may form a mask image by using a segment anything model (SAM), which is the foundation model. A second image segmentation unit may form the mask image by using semiconductor segment anything for metrology & inspection (SeSAMI), which is the foundation model. In an embodiment, the SeSAMI may be a semiconductor structure dedicated foundation model based on the foundation model SAM. In an embodiment, the SeSAMI may be any semiconductor structure dedicated foundation model. A third image segmentation unit may form a ground truth image by using SegGPT which is the foundation model. The SegGPT may be a few-shot learning based foundation model that performs image segmentation only with a small number of input data.

The ground truth data management unit 30 may perform a step S200 of managing the source ground truth data (SGTD) (see FIG. 3), and a step S500 of managing the ground truth data (GTD) (see FIG. 3). The ground truth data management unit 30 may include a database and a data preprocessing unit. The database may receive and store files, each file including a source raw image (SRI) (see FIG. 3) and the source ground truth data (SGTD), or a raw image (RI) (see FIG. 3) and the ground truth data (GTD). In an embodiment, the files may include an image file, for example in a JPG, JPEG, TIF, GIF, or PNG format. The data preprocessing unit may receive, from the database, files including the source raw image (SRI) and the source ground truth data (SGTD), or the raw image (RI) and the ground truth data (GTD), and may preprocess the received files. The files are preprocessed to be standardized to meet a foundation model learning or image segmentation model learning standard. The preprocessed files may be stored in the database again.

The foundation model 40 may perform a step 300 (e.g., 300A or 300B) of learning the foundation model. In an embodiment, the foundation model 40 may include the SeSAMI. In an embodiment, the foundation model 40 may include the SegGPT. The foundation model 40 may be learned by an in-context learning method, a few-shot learning method, or a zero-shot learning method. The foundation model 40 may perform pre-learning. The pre-learned foundation model 40 may perform fine tuning training. In an embodiment, the fine tuning training may be performed by parameter efficient fine-tuning (PEFT).

The image segmentation model 50 may perform a step 600 of learning the image segmentation model and a step 700 of inferring the image segmentation model. The image segmentation model 50 may include a learning unit and an inference unit. The learning unit may perform image segmentation learning based on the source ground truth data (SGTD) (see FIG. 3) and the ground truth data (GTD) (see FIG. 3) The inference unit may create an inference image (IFI) (see FIG. 3) from a new raw image (NRI) (see FIG. 3).

The measurement unit 60 may perform a step 800 of measuring the semiconductor structure (e.g., the geometry and/or core structure of an integrated circuit, semiconductor chip, a memory device such as DRAM or Flash, a logic circuit, another semiconductor device, or lot). The measurement unit 60 may measure a specification of each material or structure from the inference image IFI, and create a measurement result image (MRI) (see FIG. 3).

FIG. 3 is a diagram illustrating additional details of the system 10 and method for automatically measuring a semiconductor structure of FIG. 2, according to an embodiment.

Referring to FIG. 3, the method for automatically measuring a semiconductor structure may include a step 100 of creating source ground truth data (SGTD), a step 200 of managing the source ground truth data (SGTD), a step 300A of learning a foundation model, a step 400 of creating ground truth data (GTD), a step 500 of managing the ground truth data (GTD), a step 300B of learning the foundation model, a step 600 of learning an image segmentation model, a step 700 of inferring the image segmentation model, and a step 800 of measuring the semiconductor structure, as in the example of FIG. 2.

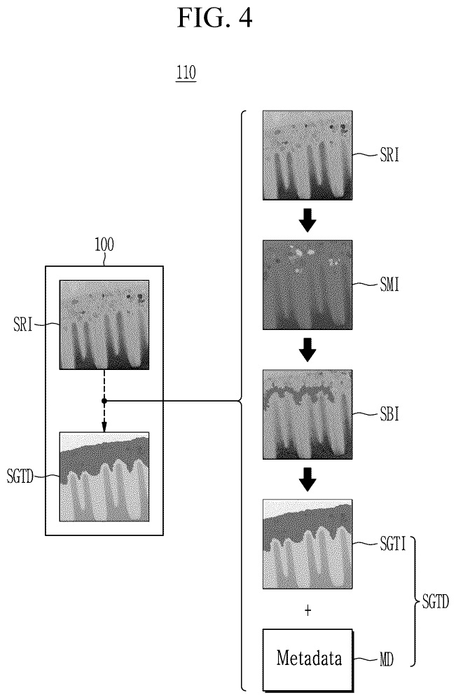

The step 100 of creating the source ground truth data SGTD may include a step 110 of acquiring the source ground truth data SGTD from a source raw image SRI. Additional details of the step 110 of acquiring the source ground truth data SGTD from the source raw image SRI are illustrated in FIG. 4.

Referring to FIGS. 3 and 4, the semiconductor structure is captured by an electron microscope to acquire the source raw image SRI. In an embodiment, the electron microscope may include a scanning electron microscope or a transmission electron microscope. For example, the source raw image SRI may include an electron micrograph of a semiconductor structure, such as an integrated circuit formed as a semiconductor chip, a memory device such as DRAM or Flash, a logic circuit, or another semiconductor device. Thereafter, a criterion and a measurement item for a boundary of the semiconductor structure may be set.

Thereafter, a source mask image (SMI) may be created based on the source raw image SRI, and the set criterion and measurement item for the boundary of the semiconductor structure. The source mask image SMI may be an image that may be used to manipulate an image segmentation result. In an embodiment, the source mask image SMI may be created by an SAM or other deep learning model. In an embodiment, the source mask image SMI may be passively created by an input of a user.

After the source mask image SMI is created, the boundary is assigned to the source mask image SMI to create a source boundary image SBI. The source boundary image SBI may create a super pixel in the source mask image SMI, and form an image segmentation region having boundary information based on the super pixel. The super pixel may extend a pixel (for example, by grouping multiple pixels into a super pixel) by dividing a region based on a contour estimated as a boundary line of the source mask image SMI. In an embodiment, creation of the source boundary image SBI may be performed by an image processing algorithm using the super pixel.

After the source boundary image SBI is created, a color is assigned to the source boundary image SBI to create a source ground truth image SGTI. In an embodiment, the source ground truth image SGTI may be formed by assigning the color to each image segmentation region along the boundary of the source boundary image SBI by the user.

After the source ground truth image SGTI is created, information is stored in the source ground truth image SGTI to create the source ground truth data SGTD. For example, the source ground truth data SGTD may include the source ground truth image SGTI and the information on the source ground truth image SGTI. The information on the source ground truth image SGTI may include metadata MD. In an embodiment, the metadata MD may include at least one of a name of a material, a color of the material, a location of the material, or a name of the structure.

Referring back to FIG. 3, the step 200 of managing the source ground truth data SGTD may be performed after the step 100 of creating the source ground truth data SGTD.

In the step 200 of managing the source ground truth data SGTD, first, the source raw image SRI acquired with the electron microscope and the created source ground truth data SGTD may be jointly formed into one file F. In an embodiment, the file F including the source raw image SRI and the source ground truth data SGTD may further include at least one of the source mask image SMI or the source boundary image SBI.

After the source raw image SRI and the source ground truth data SGTD are formed as the file F, the file F may be stored in the database.

After the file F is stored in the database, the file F in the database may be preprocessed. The file F may be standardized to meet a foundation model learning or image segmentation model learning standard. In an embodiment, the preprocessing of the file F may be performed by using a finite element method (FEM). The preprocessed file F may be stored in the database again.

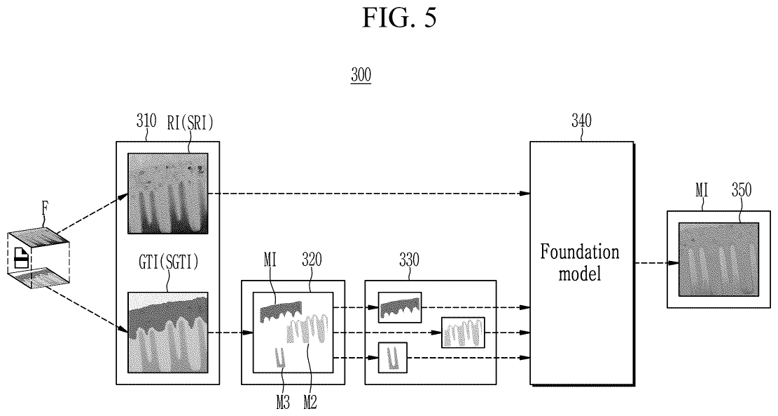

After the step 200 of managing the source ground truth data SGTD, a step 300A of learning the foundation model may be performed. Additional details of the step 300A (300) of learning the foundation model are illustrated in FIG. 5.

Referring to FIGS. 3 and 5, the step 300A of learning the foundation model may include a step 310 of separating the file F into the source raw image SRI and the source ground truth image SGTI, a step 320 of separating masks from the source ground truth image SGTI, a step 330 of extracting information stored in each of the masks, a step 340 of performing the learning of the foundation model, and a step 350 of creating a mask image MI. In an embodiment, the foundation model 40 may include semiconductor segment anything for metrology & inspection (SeSAMI) or a semiconductor dedicated deep learning model.

First, the file F may be separated into the source raw image SRI and the source ground truth image SGTI (step 310).

After the file F is separated into the source raw image SRI and the source ground truth image SGTI, masks M1, M2, and M3 may be separated from the source ground truth image SGTI (step 320). The masks M1, M2, and M3 may be separated by a criterion according to at least one of the material or the structure. The masks M1, M2, and M3 may include labels having pre-designated colors, respectively. For example, masks including the same label may have the same color.

After the masks M1, M2, and M3 are separated from the source ground truth image SGTI, information stored in each of the masks M1, M2, and M3 may be extracted (step 330). The information stored in each of the masks M1, M2, and M3 may include the metadata MD. In an embodiment, the metadata MD may include at least one of a name of a material, a color of the material, a location of the material, and a name of the structure.

After the information stored in each of the masks M1, M2, and M3 is extracted, the foundation model learning may be performed (step 340). The source raw image SRI, the source ground truth image SGTI, and the information stored in each of the masks M1, M2, and M3 may be input into the foundation model 40 in order to perform the foundation model learning. In an embodiment, the foundation model 40 may include fine tuning training. In an embodiment, the fine tuning training may be performed by parameter efficient fine-tuning (PEFT).

After the foundation model learning is performed, a mask image MI may be created from the foundation model 40 (step 350). The mask image MI may be used for the step 400 of creating the ground truth data GTD.

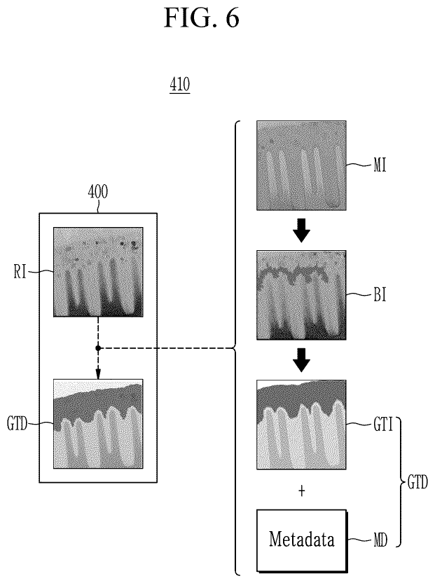

The step 400 of creating the ground truth data GTD may include a step 410 of acquiring the ground truth data GTD from the raw image RI. The step 410 of creating the ground truth data GTD from the raw image RI is illustrated in FIG. 6.

Referring to FIGS. 3 and 6, the raw image RI may be acquired by capturing the semiconductor structure with the electron microscope, and the mask image MI created by inputting the raw image RI into the foundation model 40 may be used. The mask image MI may be an image that may manipulate an image segmentation result.

Thereafter, the boundary is applied to the mask image MI to create a boundary image BI. In an embodiment, the boundary image BI may create a super pixel in the mask image MI, and form an image segmentation region having boundary information based on the super pixel. In an embodiment, the creation of the boundary image BI may be performed by an image processing algorithm using the super pixel. In an embodiment, the boundary image BI may form the image segmentation region based on the boundary information of the mask image MI created from the foundation model 40. In an embodiment, the creation of the boundary image BI may be performed by the foundation model 40.

After the boundary image BI is created, a color is applied to the boundary image BI to create a ground truth image GTI. In an embodiment, the ground truth image GTI may be formed by assigning the color to each image segmentation region along the boundary of the boundary image BI by the user.

After the ground truth image GTI is created, information is stored in the ground truth image GTI to create the ground truth data GTD. The ground truth data GTD may include the ground truth image GTI and the information on the ground truth image GTI. The information on the ground truth image GTI may include metadata MD. In an embodiment, the metadata MD may include at least one of a name of a material, a color of the material, a location of the material, or a name of the structure.

Referring back to FIG. 3, the step 500 of managing the ground truth data GTD may be performed after the step 400 of creating the ground truth data GTD.

In the step 500 of managing the ground truth data GTD, first, the raw image RI acquired with the electron microscope and the created ground truth data GTD may be jointly formed into one file (additional file) F′. In an embodiment, the file (additional file) F′ including the raw image RI and the ground truth data GTD may further include at least one of the mask image MI and the boundary image BI.

After the raw image RI and the ground truth data GTD are formed into the file (additional file) F′, the file (additional file) F′ may be stored in the database.

After the file (additional file) F′ is stored in the database, the file (additional file) F′ in the database may be preprocessed. The file (additional file) F′ may be standardized to meet a foundation model learning or image segmentation model learning standard. In an embodiment, the preprocessing of the file (additional file) F′ may be performed by using a finite element method (FEM). The preprocessed file (additional file) F′ may be stored in the database again.

According to the present disclosure, by the step 200 of managing the source ground truth data SGTD and the step 500 of managing the ground truth data GTD, image segmentation ground truth data may be managed and recycled. For example, the image segmentation ground truth data may be reused. As a result, the image segmentation ground truth data may be rapidly created for a new semiconductor device, and the accuracy of the image segmentation ground truth data for the new semiconductor device may be enhanced.

After the step 500 of managing the ground truth data GTD, a step 300B of learning the foundation model may be performed. The step 300B (300) of learning the foundation model is illustrated in FIG. 5.

Referring to FIGS. 3 and 5, the step 300B of learning the foundation model may include a step 310 of separating the file (additional file) F′ into the raw image RI and the ground truth image GTI, a step 320 of separating masks from the ground truth image GTI, a step 330 of extracting information stored in each of the masks, a step 340 of performing the learning of the foundation model, and a step 350 of creating the mask image MI. In an embodiment, the foundation model 40 may include semiconductor segment anything for metrology & inspection (SeSAMI) or a semiconductor dedicated deep learning model.

First, the file (additional file) F′ may be separated into the raw image RI and the ground truth image GTI (step 310).

After the file (additional file) F′ is separated into the raw image RI and the ground truth image GTI, masks M1, M2, and M3 may be separated from the ground truth image GTI (step 320). The masks M1, M2, and M3 may be separated by a criterion according to at least one of the material and the structure. The masks M1, M2, and M3 may include labels having pre-designated colors, respectively. Masks including the same label may have the same color.

After the masks M1, M2, and M3 are separated from the ground truth image GTI, information stored in each of the masks M1, M2, and M3 may be extracted (step 330). The information stored in each of the masks M1, M2, and M3 may include the metadata MD. In an embodiment, the metadata MD may include at least one of a name of a material, a color of the material, a location of the material, or a name of the structure.

After the information stored in each of the masks M1, M2, and M3 is extracted, the foundation model learning may be performed (step 340). The raw image RI, the ground truth image GTI, and the information stored in each of the masks M1, M2, and M3 may be input into the foundation model 40 in order to perform the foundation model learning. In an embodiment, the foundation model 40 may include fine tuning training. In an embodiment, the fine tuning training may be performed by parameter efficient fine-tuning (PEFT). As such, since the information stored in each of the masks M1, M2, and M3 may be utilized for learning the foundation model, information on the entire semiconductor structure is utilized for learning the foundation model to establish a boundary and a measurement criterion of the material or the structure of the entire semiconductor structure.

After the foundation model learning is performed, a mask image MI may be created from the foundation model 40 (step 350). Thereafter, it may be determined whether the boundary of the mask image MI meets a predetermined boundary criterion. Responsive to the boundary of the mask image MI meeting the predetermined boundary criterion, the mask image MI may be provided in the step of creating the ground truth data GTD. Responsive to the boundary of the mask image MI not meeting the predetermined boundary criterion, the mask image MI may be modified or recreated.

Referring to FIGS. 2 and 3, the step 400 of creating the ground truth data GTD, the step 500 of managing the ground truth data GTD, and the step 300B of learning the foundation model may be repeated. In a step in which the steps 400, 500, and 300B are performed n times, the raw image, the ground truth data, the ground truth image, and the information may be defined as an n-th raw image, n-th ground truth data, an n-th ground truth image, and n-th information, respectively. Here, n may increase by 1 whenever the step is repeated from 1. As such, since the system 10 for automatically measuring the semiconductor structure according to the present disclosure may have a data engine structure configured in the form of circulation, and repeatedly perform foundation model learning based on metadata by a data engine structure configured in the form of circulation, the system 10 may significantly enhance the performance of the foundation model. For example, the disclosed steps may be repeated to improve the learning of the foundation model. The number of repetitions may be determined by reaching a desired level of performance for the foundation model, and/or the number of repetitions may reach a predetermined maximum value based on available computational resources. Further, according to the present disclosure, the ground truth data may be automatically created by utilizing the foundation model learning to rapidly create image segmentation ground truth data having high analysis accuracy.

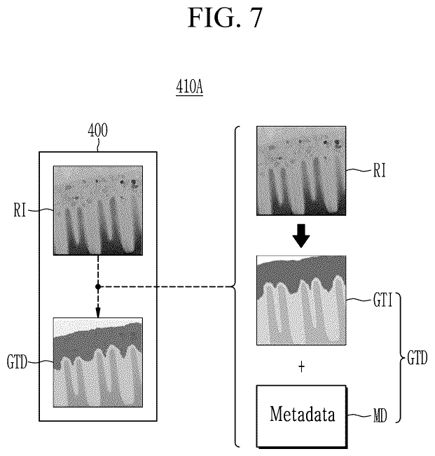

The ground truth data GTD may be acquired from the raw image RI by utilizing SegGPT which is the foundation model. A step 410A of creating the ground truth data GTD from the raw image RI by utilizing the SegGPT which is the foundation model is illustrated in FIG. 7. For example, the step 410A may be performed as an alternative to the step 410 of creating the ground truth data GTD from the raw image RI of FIG. 6.

Referring to FIGS. 3 and 7, the raw image RI may be acquired with the electron microscope, and a learning image LI may be acquired from the foundation model 40, which may be SegGPT. The SegGPT is a few-shot learning based foundation model that creates the learning image LI by performing image segmentation only with a small number of source ground truth images SGTI. After the learning image LI is created from the SegGPT, the ground truth image GTI may be created by assigning the color to the image segmentation region by using a drawing tool based on an input of a user. After the ground truth image GTI is created, information is stored in the ground truth image GTI to create the ground truth data GTD. The ground truth data GTD may include the ground truth image GTI and the information on the ground truth image GTI. The information on the ground truth image GTI may include metadata MD. In an embodiment, the metadata MD may include at least one of a name of a material, a color of the material, a location of the material, or a name of the structure.

Contents described in the description regarding FIGS. 3 and 6 may be applied to contents other than contents described regarding FIG. 7.

Referring back to FIG. 3, after the step 500 of managing the ground truth data GTD, a step 600 of learning the image segmentation model may be performed.

In the step 600 of learning the image segmentation model, image segmentation model learning may be performed utilizing the plurality of files stored in the database. The raw image RI and the ground truth data GTD stored in the database are input into the image segmentation model 50 to perform the image segmentation model learning. Thereafter, it may be determined whether the performance of the learned image segmentation model 50 meets a predetermined criterion. When the performance of the image segmentation model 50 meets the predetermined criterion, a step 700 of inferring the image segmentation model may be performed. When the performance of the image segmentation model 50 does not meet the predetermined criterion, the raw image RI and the ground truth data GTD may be additionally collected, or the raw image RI and the ground truth data GTD which are already stored may be modified.

After the step 600 of learning the image segmentation model, the step 700 of inferring the image segmentation model may be performed.

In the step 700 of inferring the image segmentation model, a new raw image NRI may be input into the image segmentation model 50, and an inferred image IFI may be created from the image segmentation model 50. For example, the new raw image NRI may include an electron micrograph of a semiconductor structure to be measured and/or analyzed, such as an integrated circuit formed as a semiconductor chip, a memory device such as DRAM or Flash, a logic circuit. or another semiconductor device.

After the step 700 of inferring the image segmentation model, a step 800 of measuring the semiconductor structure may be performed.

In the step 800 of measuring the semiconductor structure, the inferred image IFI is input into the measurement unit 60 to create a measurement result image MRI. The measurement result image MRI may include a specification of each material or structure measured. Thereafter, it may be determined whether the specification of the measurement result image MRI meets a predetermined criterion. Responsive to the specification of the measurement result image MRI meeting the predetermined criterion, the measurement result image MRI may be stored. The stored measurement result image MRI can be used to measure and/or analyze a semiconductor structure, for example during a semiconductor development and/or manufacturing process. Responsive to the specification of the measurement result image MRI not meeting the predetermined criterion, the raw image RI and the ground truth data GTD may be additionally collected, or the raw image RI and the ground truth data GTD which are already stored may be modified, and then the step 600 of learning the image segmentation model may be performed again.

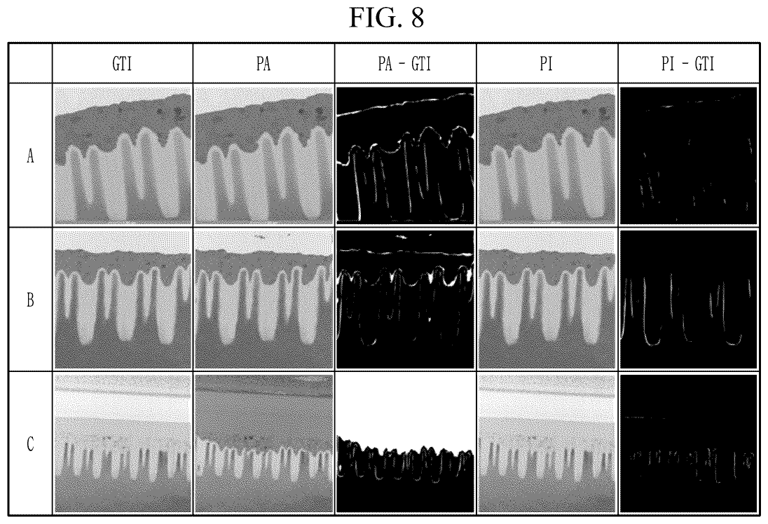

FIG. 8 is a diagram illustrating comparison of performances of a ground truth image PA in other systems and a ground truth image PI of the present disclosure. In particular, the disclosed system and methods can improve over other systems for analyzing electron micrographs showing the structure of a semiconductor device (e.g., an integrated circuit formed as a semiconductor chip, a memory device such as DRAM or Flash, and/or a logic circuit), by providing consistently high image segmentation performance.

In some examples, the steps 700 and 800 may be repeated for multiple new raw images NRI. For example, in a case where multiple semiconductor devices and/or structures are to be measured, the steps 700 and 800 can be repeated for each new raw image NRI. For example, the foundation model 40 may be reused.

Referring to FIG. 8, a table shows performances of an actual ground truth image GTI, the ground truth image PA in other systems, and the ground truth image PI according to the present disclosure, for product A in which learning is performed, product B in which learning is not performed (similar to product A), and product C in which learning is not performed (similar to product A, but having a different measurement environment).

For product A in which learning is performed, it is shown that the ground truth image PI of the present disclosure and the actual ground truth image GTI are similar to each other, and it can be seen that the ground truth image PI of the present disclosure has high performance.

For product A in which learning is performed, it is shown that the ground truth image PA in other systems and the actual ground truth image GTI are similar to each other, and it can be seen that the ground truth image PA in other systems also has high performance.

For product B similar to product A, in which learning is not performed, it is shown that the ground truth image PI of the present disclosure and the actual ground truth image GTI are similar to each other, and it can be seen that the ground truth image PI of the present disclosure has high performance.

For product B similar to product A, in which learning is not performed, it is shown that the ground truth image PA in other systems and the actual ground truth image GTI are different from each other, and it can be seen that the ground truth image PA in other systems shows a reduced performance compared to the ground truth image PI of the present disclosure.

For product C similar to product A, but having the different measurement environment, in which learning is not performed, it is shown that the ground truth image PI of the present disclosure and the actual ground truth image GTI are similar to each other, and it can be seen that the ground truth image PI of the present disclosure has high performance.

For product C similar to product A, but having the different measurement environment, in which learning is not performed, it is shown that a difference between the ground truth image PA in other systems and the actual ground truth image GTI is very large, and it can be seen that the ground truth image PA in other systems shows a significantly reduced performance compared to the ground truth image PI of the present disclosure.

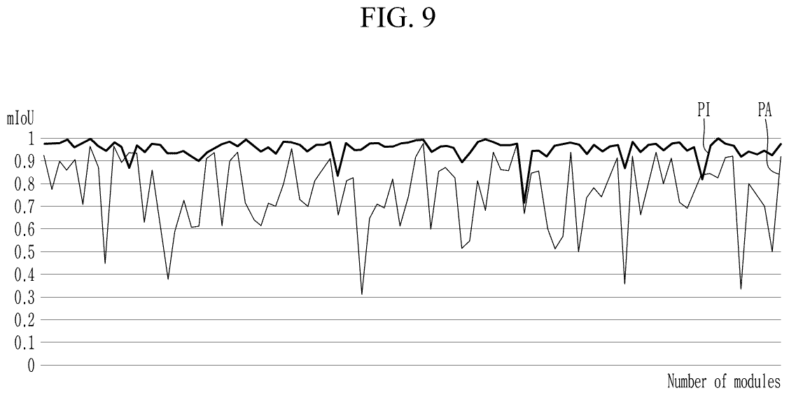

FIG. 9 is a graph evaluating and illustrating the performance of the ground truth data learned by the foundation model.

Referring to FIG. 9, the graph shows a mIoU value according to the number of module. mIoU means an average value for an intersection of union (IoU) value for each material or structure. IoU means (overlap area of actual ground truth image and compared ground truth image)/(union area of actual ground truth image and compared ground truth image). Accordingly, an IoU value closer to 1 means a better agreement between the actual ground truth image and compared ground truth image, and hence better image segmentation performance. The IoU has a value between 0 and 1.

When the graph is examined, it can be seen that the IoU of the ground truth image PA in other systems shows that an image segmentation performance is low with respect to various modules. In this regard, it can be seen that the ground truth image PI of the present disclosure shows a high performance with respect to all modules regardless of whether to participate in learning. Thus, the disclosed system and methods can improve over other systems for analyzing electron micrographs showing the structure of a semiconductor device (e.g., an integrated circuit formed as a semiconductor chip, a memory device such as DRAM or Flash, and/or a logic circuit), by providing consistently high image segmentation performance of the electron micrographs with respect to all modules, and improved segmentation performance for virtually all modules.

In addition, the disclosed system and methods can also improve over other systems by generating correct data with high consistency between users, while minimizing user intervention. Information on the entire semiconductor device can be obtained by utilizing material and structural information as metadata. Finally, the disclosed system and methods can improve the repetitive work of setting up the model for each device by providing a model that is robust against semiconductor device variations and/or fluctuations (e.g., the model does not need to be learned for each semiconductor device).

According to the present disclosure, even though the ground truth image is created with respect to a product in which learning is not performed, or a product measured in a measurement environment in which a structure or a magnification is different, a ground truth image having a consistent quality may be accurately created. Accordingly, a system for automatically measuring the semiconductor structure which is enabled to be applied to a semiconductor product accompanied by various experiment and process changes may be provided according to embodiments of the present disclosure.

Although a preferred embodiment of the present disclosure is described hereinabove, the present disclosure is not limited thereto, and various modifications can be made within the scopes of the claims, and the detailed description of the present disclosure and the accompanying drawings, and belongs to the scope of the present disclosure, of course.

What is claimed is:

1. A method for automatically measuring a semiconductor structure, the method comprising:
receiving a microscope image of the semiconductor structure;
creating source ground truth data for a source raw image including the microscope image of the semiconductor structure, wherein the source ground truth data includes a source ground truth image, and information on the source ground truth image;
learning a foundation model based on the source raw image, and based on the information on the source ground truth image;
creating respective ground truth data for a respective raw image by utilizing the learned foundation model, wherein the respective ground truth data includes a respective ground truth image and respective information for the respective ground truth image; and
learning the foundation model based on the respective raw image, and based on the respective information on the respective ground truth image,
wherein the creating of the respective ground truth data for the respective raw image by utilizing the learned foundation model, and the learning of the foundation model based on the respective raw image, and based on the respective information for the respective ground truth image are repeated.

2. The method of claim 1, wherein:
the creating of the source ground truth data for the source raw image including the semiconductor structure includes,
creating a source mask image,
assigning a boundary to the source mask image to create a source boundary image, and
assigning a color to the source boundary image to create the source ground truth image.

3. The method of claim 2, wherein:
the source mask image is created by at least one of a passive learning model or a deep learning model.

4. The method of claim 2, wherein:
the assigning the boundary to the source mask image to create the source boundary image is performed by an image processing algorithm using a super pixel.

5. The method of claim 2, wherein:
the source boundary image includes a super pixel which extends a pixel by dividing a region, wherein the dividing is based on a contour estimated as a boundary line of the source mask image.

6. The method of claim 1, wherein:
the learning of the foundation model based on the source raw image, and based on the information on the source ground truth image includes:
separating a plurality of masks from the source ground truth image by a criterion according to at least one of a material or a structure,
extracting the information from each of the plurality of masks, and
creating a mask image by inputting the source raw image and the extracted information into the foundation model.

7. The method of claim 1, wherein:
the creating of the respective ground truth data for the respective raw image by utilizing the learned foundation model includes:
creating a mask image by inputting the respective raw image into the foundation model,
creating a boundary image based on a boundary of the mask image, and
creating the respective ground truth image by assigning a color to the boundary image.

8. The method of claim 1, wherein:
the learning of the foundation model based on the respective raw image, and based on the respective information on the respective ground truth image includes:
separating a plurality of masks from the respective ground truth image by a criterion according to at least one of a material or a structure,
extracting the respective information from each of the plurality of masks, and
creating a mask image by inputting the respective raw image and the extracted respective information into the foundation model.

9. The method of claim 1, wherein:
the creating of the respective ground truth data for the respective raw image by utilizing the learned foundation model includes,
creating a learning image by the foundation model, and
creating the respective ground truth image by assigning a color to the learning image.

10. A method for automatically measuring a semiconductor structure, the method comprising:
receiving a microscope image of the semiconductor structure;
creating source ground truth data for a source raw image including the microscope image of the semiconductor structure, wherein the source ground truth data includes a source ground truth image, and source metadata stored in the source ground truth image;
creating a file including the source raw image and the source ground truth data, and storing the file in a database to manage the source ground truth data;
separating the source raw image and the source ground truth data from the file, and extracting the source metadata from the source ground truth data;
learning a foundation model based on the source raw image, and based on the extracted source metadata;
creating ground truth data for a raw image by utilizing the learned foundation model, wherein the ground truth data includes a ground truth image, and metadata stored in the ground truth image;
creating an additional file including the raw image and the ground truth data, and storing the additional file in the database to manage the ground truth data;
separating the raw image and the ground truth data from the additional file, and extracting the metadata from the ground truth data; and
learning the foundation model based on the raw image, and based on the extracted metadata,
wherein the creating of the ground truth data, the managing of the ground truth data, the separating of the raw image and the ground truth data from the additional file, and extracting of the metadata from the ground truth data, and the learning of the foundation model based on the raw image and based on the extracted metadata are repeated.

11. The method of claim 10, wherein:
the foundation model includes a semiconductor dedicated deep learning model.

12. The method of claim 10, wherein:
each ground truth image includes a plurality of masks.

13. The method of claim 12, wherein:
each of the plurality of masks includes a label,
the label has a pre-designated color, and
masks including the same label have the same pre-designated color.

14. The method of claim 12, wherein:
each of the plurality of masks includes the metadata.

15. The method of claim 10, wherein:
the source metadata or the metadata includes at least one of a name of a material, a color of the material, a location of the material, and a name of a structure.

16. The method of claim 10, wherein:
the learning of the foundation model based on the source raw image, and based on the extracted source metadata includes:
inputting the source raw image and the source metadata into the foundation model,
performing fine tuning training for the foundation model, and
creating a mask image from the foundation model.

17. The method of claim 16, wherein:
the performing of the fine tuning training for the foundation model is performed by parameter efficient fine-tuning (PEFT).

18. A method for automatically measuring a semiconductor structure, the method comprising:
receiving a plurality of microscope images of one or more semiconductor structure;
creating a plurality of source ground truth data for a plurality of source raw images, wherein each of the plurality of source raw images includes a respective one of the plurality of microscope images of the one or more semiconductor structure;
creating a plurality of files, each file including respective source ground truth data among the plurality of source ground truth data, and a corresponding source raw image among the plurality of source raw images, and storing the plurality of files in a database to manage the plurality of source ground truth data;
learning a foundation model by utilizing the plurality of files stored in the database;
creating ground truth data for a raw image by utilizing the learned foundation model;
creating an additional file including the ground truth data and the raw image, and storing the additional file in the database to manage the ground truth data;
learning the foundation model by utilizing the additional file stored in the database, wherein the creating of the ground truth data, the managing of the ground truth data, and the learning of the foundation model by utilizing the additional file are repeated;
learning an image segmentation model by utilizing the plurality of files stored in the database, and utilizing a plurality of additional files stored in the database, and including respective additional files created by the repeated creating of the ground truth data, managing of the ground truth data, and learning of the foundation model by utilizing the additional file;
inferring a new image by utilizing the image segmentation model to create an inferred image; and
measuring one or more feature of the one or more semiconductor structure from the inferred image.

19. The method of claim 18, wherein:
the creating of the ground truth data for the raw image by utilizing the learned foundation model includes:
creating a mask image from the learned foundation model
determining whether a boundary of the mask image meets a predetermined boundary criterion, and
responsive to the mask image not meeting the predetermined boundary criterion, modifying or recreating the mask image.

20. The method of claim 18, wherein:
the automatically measuring of the semiconductor structure from the inferred image includes:
measuring the semiconductor structure,
determining whether a measurement result meets a predetermined criterion, and
responsive to the measurement result not meeting the predetermined criterion, returning to the learning of the image segmentation model.
